(19) United States
(12) Patent Application Publication
(10) Pub. No.: US 2014/0205367 A1
(43) Pub. Date: Jul. 24, 2014

(54) Conenctor configuration for an assembled modular rack

(71) Applicant: Cheng-Kang Sung, Taichung (TW)

(72) Inventor: Cheng-Kang Sung, Taichung (TW)

(21) Appl. No.: 13/694,984

(22) Filed: Jan. 24, 2013

(51) Int. Cl. F16B 12/02

(52) U.S. Cl. CPC F16B 12/02
USPC 403/192

(57) ABSTRACT

Disclosed is an assembled connector configuration for a modular rack used for receiving a plane object. It comprises a fan-shaped receiving portion and a joinder, the receiving portion has at least one holes. The joinder is a column having a first and a second columnar opening, the opening diameter of the first columnar opening is smaller than that of the second columnar opening. The joinder can be lassoed around at least a post of a modular rack, and can be locked by a set of circular plates into a fixed position at an appropriate location on the post; the receiving portion is placed at one of the four corners of a rectangular plane object. The rectangular plane object is placed at the receiving portion before locked into a fixed location by a fastening member, in order to be secured on the rectangular plane object, to establish a modular rack connector.

### BACKGROUND OF THE INVENTION

1. Field of the Invention

The present invention relates to a connector configuration for an assembled modular rack, pointing to an improved combination configuration for an assembled modular rack, particularly to a member composed of multi-sectional metal column and metal webbing placing plate, which is oriented toward improving modular rack. The modular rack is assembled by the following: putting together a connector with a rectangular plate object or a glass plate, fastening them together with a screw to establish a placing plate, setting the receiving column of the placing plate onto metal post, covering the post at an appropriate location by a clamping member, in which the connector is securely positioned at an appropriate location of the metal post by the clamping member.

2. Description of Related Art

The present invention takes advantage of an assembled metal modular rack as the improvement basis, which is based on U.S. Pat. No. 5,676,263. The cited patent is described as follows: a modular rack for placing objects thereon, comprising: at least three spaced post units, each of which includes a hollow upper post, a cylindrical connector, and a hollow lower post, each of said upper and lower posts having an outer surface formed with a plurality of annular peripheral grooves, said upper post having an internally threaded bottom end, said lower post having an internally threaded top end, said connector having an externally threaded upper portion which extends into and which engages threadedly said internally threaded bottom end of said upper post, said connector further having an externally threaded lower portion which extends into and which engages threadedly said internally threaded top end of said lower post, and a radially protruding flange portion between said upper and lower portions, said flange portion having an outer diameter smaller than that of said upper and lower posts and cooperating with said upper and lower posts to form an annular retaining groove; a plurality of tubular sleeves sleeved on said post units, each of said tubular sleeves being formed with a radially inward protrusion which extends into a selected one of said peripheral and retaining grooves in said upper and lower posts; and a plurality of trays, each of which has a peripheral portion provided with at least three spaced positioning tubes, each of which is sleeved tightly on one of said tubular sleeves, each of said trays having a length which is at least equal to length of each of said upper and lower posts.

In the combined elements for the above configuration, all the elements therein except the curved pieces are made of metal, trays 21 and positioning tubes 23 are linked together by phase welding, Such working renders it impossible to change the material for the trays 21, and the tray body 211 of the trays 21 is composed of multiple metal separators, so there are hollow spaces created by such separation on the placing plate, therefore for the purpose of placing objects, in the event for that these hollow spaces are found to be smaller than the required specification, there needs to be placed a rectangular plane object on the tray body 211, in order to prevent objects from falling from the hollow space. Consequentially, this would directly incur the cost for producing the elements, as well as packaging volume.

### SUMMARY OF THE INVENTION

The connector configuration for the assembled modular rack, in particular a connector for receiving a rectangular plane object, has a receiving portion and a joinder, these two members are connected to become one body, the receiving portion is connected to the wall surface of a radial tube outer edge of the joinder, the receiving portion is a fan-shaped plane, the plane is disposed with a first border and a second border formed by the bending of a section of the receiving portion, the plane surface is disposed with at least one hole The described joinder is a conical column, which has the first columnar opening and the second columnar opening, the opening diameter of the first columnar opening is smaller than the opening diameter of the second columnar opening; the described receiving portion can receive one of four corners of a rectangular plane object.

The associated metal post, clamping member combination can be combined into a modular rack, the described metal post is used to serve as the supporting elements for the four corners of the four rectangular corners for the modular rack. The post is a columnar constituent, whose appearance has circular indentation. The post itself is circular, rod-shaped material, it is made of aluminum or steel. The circular indentation is a disposition formed by a separation arrangement from the top of the post to the bottom of the post. A clamping member, it includes two congruent semi-circular plate objects, the semi-circular plane object basically includes a leaf portion and a groove portion, wherein the groove portion and the leaf portion correspond to each other, and an inter-engaged leaf portion and the groove portion presents a conical column looking shape. The surface of the semi-circular plane is disposed with congruent protruding ribs, whose function is to help the connector to securely clamp onto the post at an appropriate location.

In continuation of the above, when the two semi-circular plane objects are inter-engaged in the said manner, when the two semi-circular plane objects are installed on the post, the protruding ribs are connected onto the circular indentation of the post to make a clamping element and can circle around the post. In other words, the clamping element can be positioned on the post at a position of any perpendicular height, and can rotate along the circular indentation to function as an element fastening means.

By positioning the clamping element in advance on the post by the above clamping element, it is possible, by way of first providing the joinder of the connector of the current invention to enclose onto the post, through the characteristic of the conical column, and then passing the second columnar opening through the upper circular portion of the clamping element, to make the clamping element to be firmed secured with the connector by the working of the first columnar opening's gradually shrinking opening diameter. An additional proceeding is to lock and connect the four corners of a rectangular plane object respectively to the plane surface of the receiving portion, to combine theretofore a comprehensive configuration of a modular rack.

### BRIEF DESCRIPTION OF THE DRAWINGS

FIG. 1 is an isometric view of embodiment 1 of the connector according to the present invention.

FIG. 2 is an isometric view of embodiment 2 of the connector according to the present invention.

FIG. 3 is an isometric view of embodiment 3 of the connector according to the present invention.

FIG. 4 shows an exploded view of the connector, the post, and the clamping members according to the present invention.

FIG. 5 is an exploded view of embodiment 1 of the connector configuration for a modular rack according to the present invention.

FIG. 6 is an exploded view of embodiment 2 of the modular rack according to the present invention.

FIG. 7 is a view of embodiment 2 showing assembled form of the modular rack according to the present invention.

### DETAILED DESCRIPTION OF THE PREFERRED EMBODIMENT

Preferred embodiments and associated drawings are provided below for detailed description to fully teach the current invention. In view of the drawings for the preferred embodiments for the current invention, skilled persons in the relevant technology to the current invention is expected to be able to make and use the invention based on the description of the current specification, and such is not to restrict the scope of technology of the current invention.

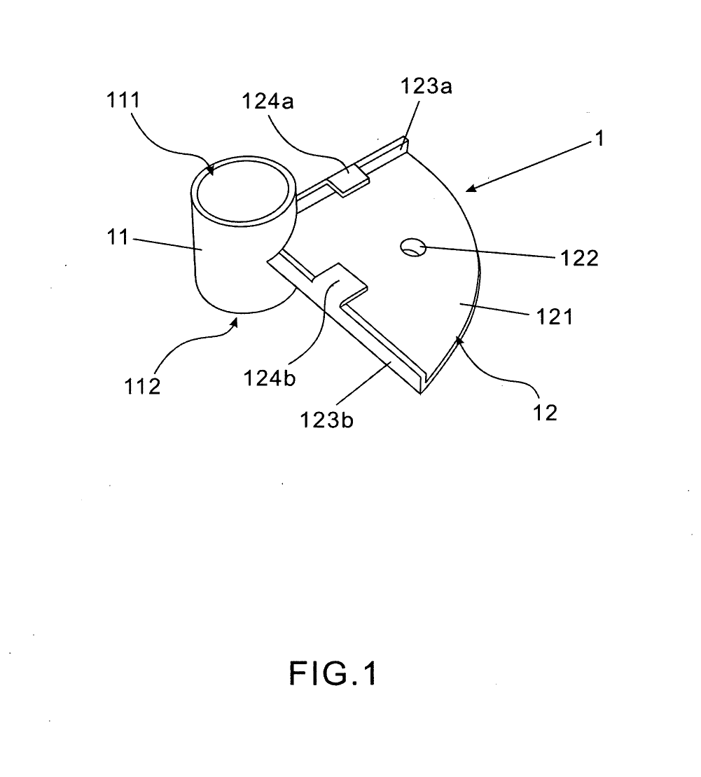

First, reference is drawn to FIGS. 1, 2, 3, which show three kinds of embodiments for the configuration of the present invention: FIG. 1 provides a connector 1 configuration for connecting with a rectangular glass plate 21, the connector 1 comprises: a receiving portion 12 and a joinder 11, the two elements are connected into a single body, the receiving portion 12 has a fan-shaped planet surface 121, plane surface 121 is connected to the radial portion of the joinder 11, the plane surface 121 is disposed with a first border 123a and a second border 123b formed by bending of a portion of the plane surface 121. There is disposed with a first support portion 124a formed by bending of a portion of an upper edge of the first border 123a, there is disposed with a second support portion 124b formed by bending of a portion of an upper edge of the second border 124a. The plane surface 121 has at least one holes 122. The joinder 11 is a conical column, which has a first columnar opening 111 and a second columnar 112, the opening diameter of the first columnar opening 111 is smaller than the opening diameter of the second columnar opening 112; the receiving portion 12 works a place for receiving one of four corners of a rectangular glass plate 21, the rectangular glass plate 21 and the connector 1 are connected by the manner of: inserting the four corners of the rectangular glass plate 21 into the receiving portion 12, to make the plane surface 121 of the receiving portion 12 to stretch against in parallel to the rectangular glass plate 21, and the first border 123a and the second border 123b wrap around the corners of the rectangular glass plate, also the first support portion 124a and the second support portion 124b operate to be wedged on the plane surface of the corner of the rectangular glass plate 21 to prevent detachment and dislocation of the connector 1.

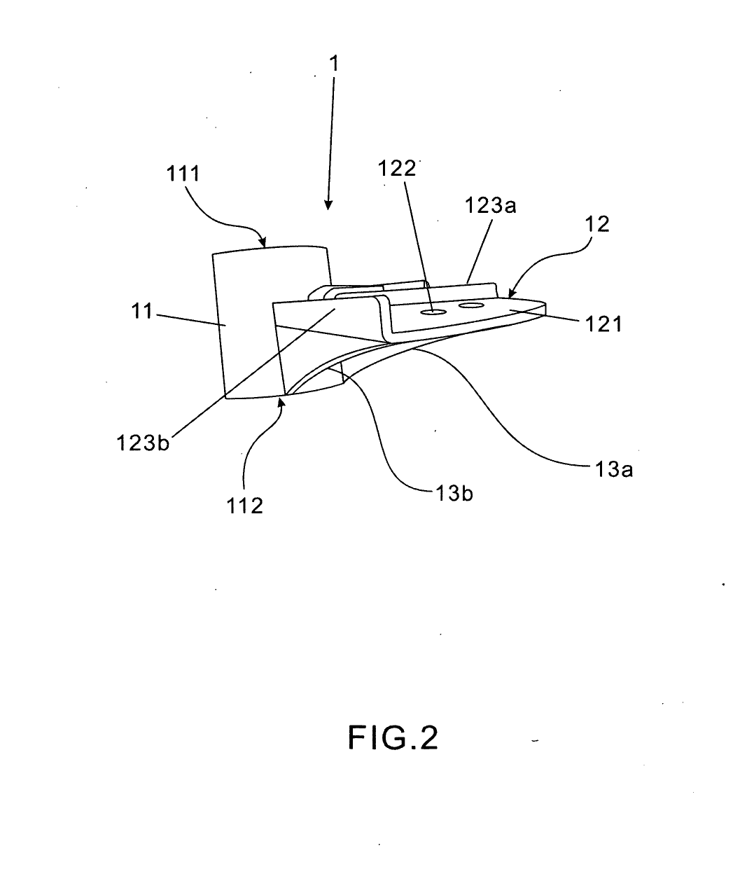

FIG. 2 shows an embodiment of the configuration for connector 1 for connecting with a rectangular plate object 22, the connector 1 comprises: a receiving portion 12 and a joinder 11, the two elements are connected into a single body, the receiving portion 12 has a fan-shaped plane surface 121, the plane surface 121 is connected to the radial portion of the joinder 11, the plane surface 121 has a first border 123a and a second border 123b formed by a bending of the plane surface 121, the plane surface 121 has at least one holes 122, below the plane surface 121 is a portion extending to connect to rib-shaped structures 13a, 13b, the rib-shaped structures 13a, 13b are connected to the outer wall column extending from below the plane surface 121 of the joinder 11. The joinder 11 is a conical column, which has a first columnar opening 111 and a second columnar opening 112, the opening diameter of the first columnar opening 111 is smaller than the opening diameter of the second columnar opening 112; the receiving portion 12 works to receive one of four corners of a rectangular plane object 22.

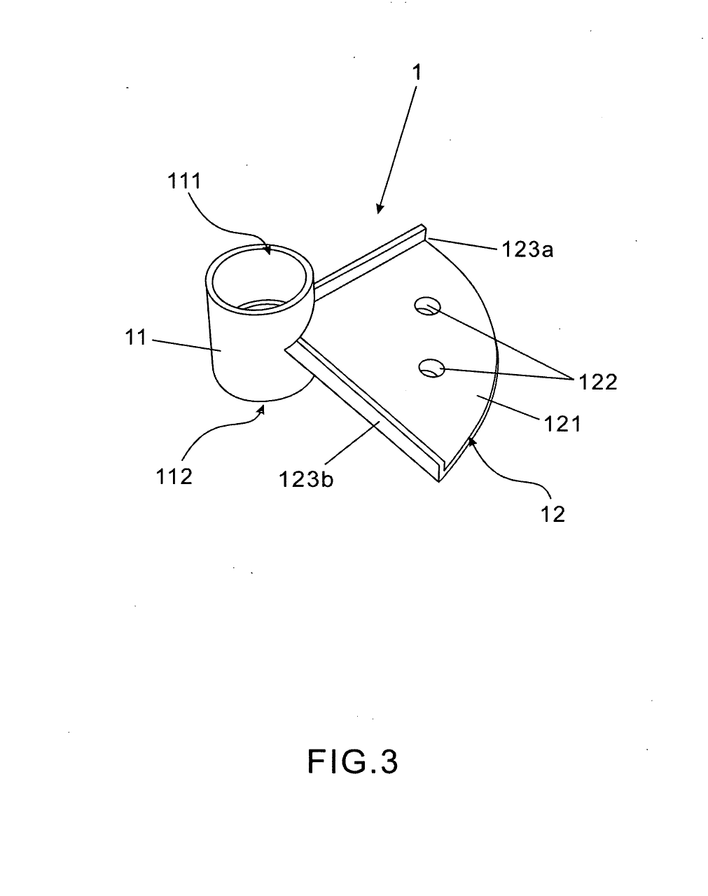

FIG. 3 shows connector 1 of embodiment 2 for receiving rectangular object 22, the connector 1 comprises: a receiving portion 12 and a joinder 11, the two elements are combined into a single body, the receiving portion 12 has a fan-shaped plane surface 121, the plane surface 121 is connected to a radial portion of the joinder 11, the plane surface 121 is disposed with a first border 123a and a second border 123b formed by a ending of the plane surface 121, the plane surface 121 has at least one holes 122. The joinder 11 is a conical column, it has a first columnar opening 111 and a second columnar opening 112, the diameter of the first columnar opening 111 is smaller than the diameter of the second columnar opening 112; the receiving portion 12 receives one of four corners of a rectangular plane object 22, the rectangular plane object 22 and the connector 1 are combined in the manner of: inserting the receiving portion 12 into the four corners of the rectangular plane object 22, to make plane surface 121 of the receiving portion 12 and the rectangular plane object 22 abut against each other, and the first border 123a and the second border 123b work to enclose the corner of the rectangular plane objet 22, so as to present the detachment and dislocation of the connector 1.

The connector 1 in assembled modular rack functions as a connecting means connecting between the placing plate the support post, the combination thereof works out to be a modular rack, whose assembly is perfected in the manner of:

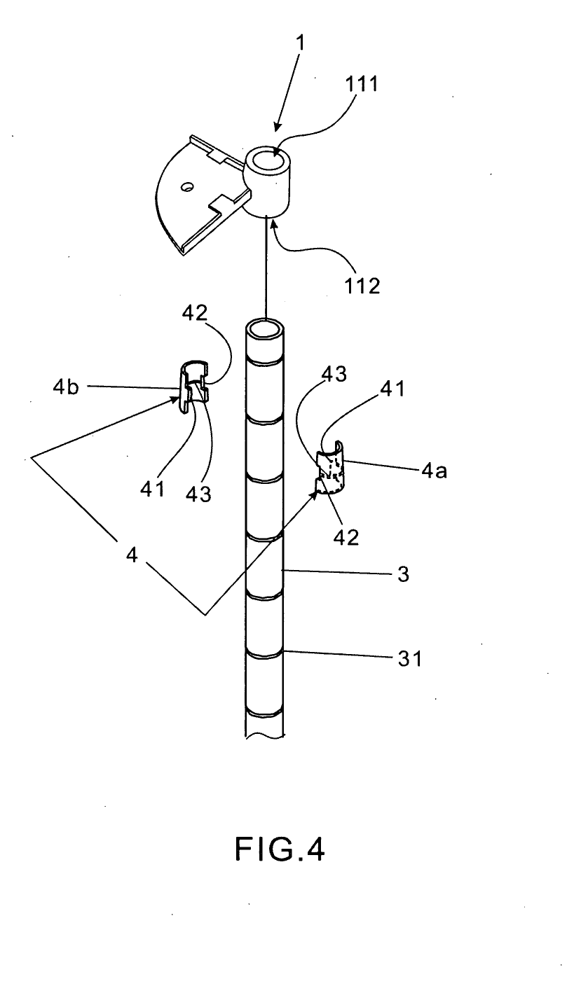

Referring now to FIG. 4, which shows a graph for the embodiment of the post 3 and the clamping member 4 and the connector 1, the post 3 is a columnar constituent, whose appearance has a circular indentation 31, the post 3 itself is a circular, rode-shaped material, it is made of aluminum or steel, the circular indentation 31 is disposed in a separated manner from the top to the bottom of the post 3; a pair of clamping members 4, which includes two congruent semi-circular plate objects 4a, 4b, the semi-circular plates 4a 4b is basically disposed of a leaf portion 41 and a groove portion 4, wherein, the groove portion 42 and the leaf portion 41 mutually correspond to each other, the inter-engaged leaf portion 41 and the groove portion 42 present a conical shape, the surface of the semi-circular plate objects 4a, 4b is disposed with congruent rib-shaped structures 43, whose function is to serve as a means for assisting the connector 1 in clamping firmly onto the post 3.

In continuation of the above, the two semi-circular plate objects 4a, 4b each correspond to match each other, when the two semi-circular plate objects 4a, 4b are installed on the post 3, the rib-shaped structure 43 treats the circular indentation 31 of the post 3 as clamping member 4 and is attached and circles thereon. In other words, the clamping member 4 can be located at any perpendicular height on the post 3, and rotates along a circular path to serve as a clamping member.

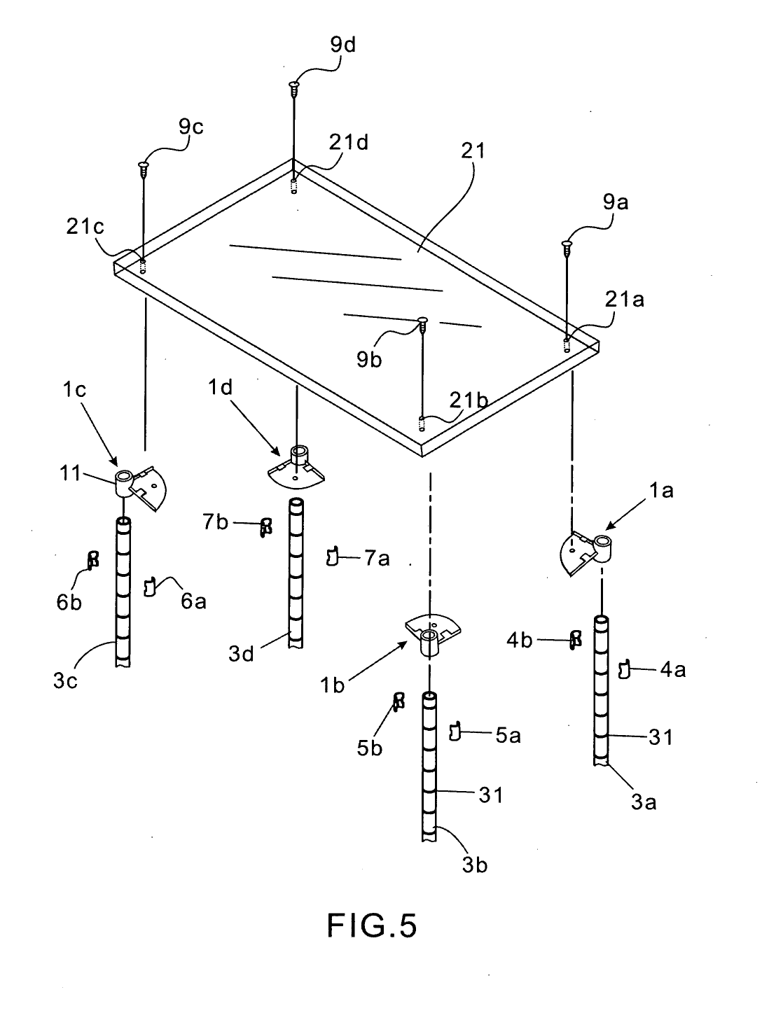

Referring now to FIG. 5, here is disclosed an embodiment of the modular rack, comprising: a rectangular glass plate 21, posts 3a, 3b, 3c, 3d, four sets of clamping members 4, locking members 9a, 9b, 9c, 9d, connectors 1a, 1b, 1c, 1d, the rectangular glass plate 21 has four holes 21a, 21b, 21c, 21d, there can be more than rectangular glass plate 21, in the current invention, an assembly having one glass plate 21 will be discussed for describing the embodiment, the embodiment requires four posts 3a, 3b, 3c, 3d and four sets of clamping members 4 and multiple locking members 9a, 9b, 9c, 9d, four connectors 1a, 1b, 1c, 1d;

First is to assemble the four corners of the rectangular glass plate 21 and the connectors 1a, 1b, 1c, 1d, passing the above assembly by the locking members 9a, 9b, 9c, 9d in a top-bottom fashion through the holes 21a, 21b, 21c, 21d, through the holes 122 of the connectors 1a, 1b, 1c, 1d, and then engage the leaf portion 41 to the groove portion 42 of the semi-circular plate objects 4a, 4b, 5a, 5c, 6a, 6b, 7a, 7b congruent to the clamping member 4, which are combined to cover appropriate parts of the posts 3a, 3b, 3c, 3d, the rib-shaped structures 43 of the semi-circular plate objects 4a, 4b, 5a, 5c 6a, 6b, 7a, 7b operate to wedge in the circular indentation 31 for fixed positioning, then, set the connectors 1a, 1b, 1c, 1d that have securely connect the connectors 1a, 1b, 1c, 1d onto the rectangular glass plate 21 onto the posts 3a, 3b, 3c, 3d, which work to respectively set the second columnar opening 112 of the joinder 11 of the connectors 1a, 1b, 1c, 1d onto the upper edges of posts 3a, 3b, 3c, 3d, before setting further toward the bottom, until further extension is not possible with the location of the clamping member 4 reaches against the plate wedge. Because the joinder 11 is conical column with a narrow top and broad bottom structure, after the semi-circular plate objects of the clamping member 4 4a, 4b, 5a, 5c, 6a, 6b, 7a, 7b are combined together, the result is a conical column with a narrow top and a broad bottom, as a result, when the opening diameter of the second columnar opening 112 of the joinder passes through the upper portion of the clamping member 4, the decrease in the opening diameter of the first columnar opening 111 work to firmly clamp onto the clamping member 4, by this way, the connector 1 is fixed to a appropriate location of the post 3, so as to form a comprehensive structure of an assembled modular rack.

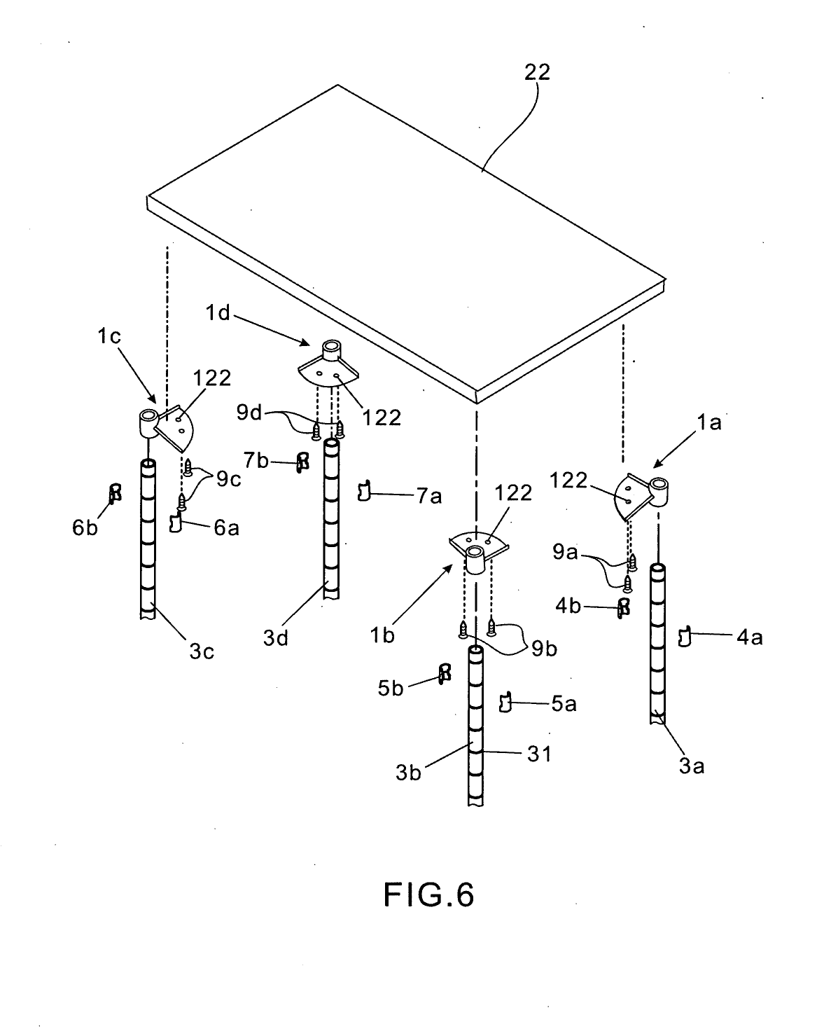

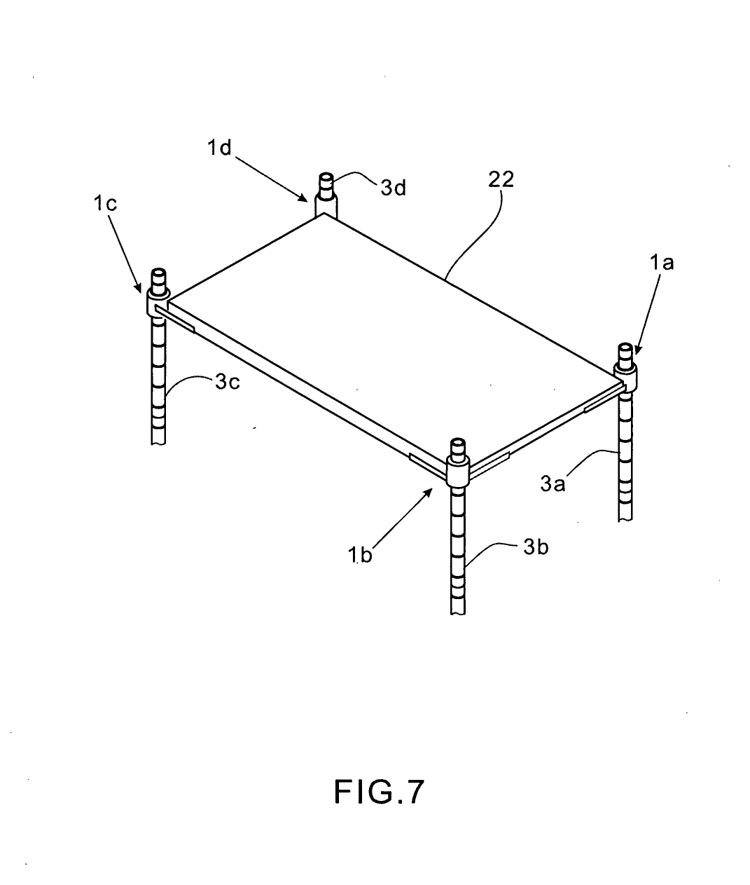

In reference to FIGS. 6 and 7, disclosed here is a second embodiment for the modular rack, comprising: a rectangular plate object 22, posts 3a, 3b, 3c, 3d, four sets of clamping members 4, locking members 9a, 9b, 9c, 9d, connectors 1a, 1b, 1c, 1d, there can be more than one of rectangular plate objects 22. An assembly having one rectangular plate object 22 will be discussed here for describing the embodiment for the present invention;

First, assemble the four corners of the rectangular glass plate 21 and the connectors 1a, 1b, 1c, 1d, passing the above assembly by the locking members 9a, 9b, 9c, 9d in a top-bottom fashion through the holes 21a, 21b, 21c, 21d, through the holes 122 of the connectors 1a, 1b, 1c, 1d, and then engage the leaf portion 41 to the groove portion 42 of the semi-circular plate objects 4a, 4b, 5a, 5c, 6a, 6b, 7a, 7b congruent to the clamping member 4, which are combined to cover appropriate parts of the posts 3a, 3b, 3c, 3d, the rib-shaped structures 43 of the semi-circular plate objects 4a, 4b, 5a, 5c 6a, 6b, 7a, 7b operate to wedge in the circular indentation 31 for fixed positioning, then, set the connectors 1a, 1b, 1c, 1d that have securely connect the connectors 1a, 1b, 1c, 1d onto the rectangular glass plate 21 onto the posts 3a, 3b, 3c, 3d, which work to respectively set the second columnar opening 112 of the joinder 11 of the connectors 1a, 1b, 1c, 1d onto the upper edges of posts 3a, 3b, 3c, 3d, before setting further toward the bottom, until the location with the clamping member 4 abuts to the plate wedge to be locked into a position, by way of this, the rectangular plate object 22 is fixed in an appropriate location of the posts 3a, 3b, 3c, 3d, so as to form a comprehensive structure of an assembled modular rack.

The connector 1 can be made of plastics or metals. In the case of plastics, embodiment of FIG. 2 is most preferable, by the rib-shaped structures 13a, 13b of the embodiment, these structures can enhance the loading structure of the plate surface of the receiving portion 121. In the case of metals, embodiments of the FIG. 1 and FIG. 2 are most preferable, it is general practice to mold a zinc-based material into a unibody structure of the receiving portion 12 and joinder 11 for the connector 1, or to press form other metal materials into the receiving portion 12 and joinder 11 respectively before welding the two into a unibody structure.

The above description only refers to a preferred embodiment of the current invention, and are not intended to be representative and limiting to the scope of protection for the present invention, Any variation or modification deriving from the claims of the current invention are covered by the claims of the current invention.

What is claimed is:

1. A connector configuration for a modular rack, which provides an improved connector configuration for a modular rack, comprising:
a receiving portion and a joinder, wherein the receiving portion and the joinder are connected together, the joinder has a plane surface, the plane surface is connected to a radial portion of the joinder, the plane surface has a section bent to form a first border and a second border, the plane surface has at least one hole; and
the joinder is a conical column, which has a first columnar opening and a second columnar opening, a first columnar opening diameter is smaller than a second columnar opening diameter, the receiving portion operates to connect to one of four corners of a rectangular plane surface.

2. The connector configuration for a modular rack according to claim 1, wherein an upper edge of the first border has a section bent to form a first supporting portion, an upper edge of the second border has a section bent to form a second supporting portion.

3. The connector configuration for a modular rack according to claim 1, wherein a rib-shaped structure is installed on an extension of an underside section of the plane surface, the rib-shaped structure extends from the underside section of the plane surface to connect to an outer wall of the joinder.

4. A connector configuration for a modular rack, which provides a connector for connecting to a rectangular plane object with four corners and sides, comprising:
a receiving portion and a joinder, wherein the receiving portion and the joinder are connected together, the receiving portion has a fan-shaped plane surface, the plane surface is connected to a radial portion of the joinder, the plane surface has a section bent to form a first border and a second border, the plane surface has at least one hole; and
the joinder is a conical column, which has a first columnar opening and a second columnar opening, a first columnar opening diameter is smaller than a second columnar opening diameter, the receiving portion operates to connect to one of four corners of a rectangular plane object, whereby the connector operates to connect to four corners and sides of the rectangular plane object, and stretches in parallel against the plane surface by the rectangular plane object, and the first border and the second border operate to enclose a vertical angle of the rectangular plane object, so as to prevent detachment and dislocation of the connector.

5. The connector configuration for a modular rack according to claim 4, wherein the upper edge of the first border has a section bent to form a first supporting portion, an upper edge of the second border has a section bent to form a second supporting portion.

6. The connector configuration for a modular rack according to claim 4, wherein a rib-shaped structure is installed on an extension of an underside section of the plane surface, the rib-shaped structure extends from the underside section of the plane surface to connect to an outer wall of the joinder.
